(19) United States
(12) Patent Application Publication
(10) Pub. No.: US 2013/0003833 A1
(43) Pub. Date: Jan. 3, 2013

(54) Scalable Video Coding Techniques

(75) Inventors: Wonkap Jang, Edgewater, NJ (US); Jill Boyce, Manalapan, NJ (US); Danny Hong, New York, NY (US)

(73) Assignee: Vidyo Inc.

(21) Appl. No.: 13/529,159

(22) Filed: Jun. 21, 2012

Related U.S. Application Data
(60) Provisional application No. 61/503,111, filed on Jun. 30, 2011.

(51) Int. Cl. H04N 7/32

(52) U.S. Cl. 375/240.12; 375/E07.243

(57) ABSTRACT

The disclosed subject matter provides techniques for inter-layer prediction using difference mode or pixel mode. In difference mode, inter-layer prediction is used to predict at least one sample of an enhancement layer from at least one (upsampled) sample of a reconstructed base layer picture. In pixel mode, no reconstructed base layer samples are used for reconstruction of the enhancement layer sample, A flag that can be part of a coding unit header in the enhancement layer can be used to distinguish between pixel mode and difference mode.

### CROSS REFERENCE TO RELATED APPLICATIONS

This application claims priority to U.S. Ser. No. 61/503,111, titled “Scalable Video Coding Technique,” filed Jun. 30, 2011, the disclosure of which is hereby incorporated by reference in its entirety.

### FIELD

The disclosed subject matter relates to techniques for encoding and decoding video using a base layer and one or more enhancement layers, where prediction of a to-be-reconstructed block uses information from enhancement layer data.

### BACKGROUND

Video compression using scalable techniques in the sense used herein allows a digital video signal to be represented in the form of multiple layers, Scalable video coding techniques have been proposed and/or standardized for many years.

ITU-T Rec. H.262, entitled “Information technology—Generic coding of moving pictures and associated audio information: Video”, version 02/2000, (available from International Telecommunication Union (ITU), Place des Nations, 1211 Geneva 20, Switzerland, and incorporated herein by reference in its entirety), also known as MPEG-2, for example, includes in some aspects a scalable coding technique that allows the coding of one base and one or more enhancement layers. The enhancement layers can enhance the base layer in terms of temporal resolution such as increased frame rate (temporal scalability), spatial resolution (spatial scalability), or quality at a given frame rate and resolution (quality scalability, also known as SNR scalability). In H.262, an enhancement layer macroblock can contain a weighting value, weighting two input signals. The first input signal can be the (upscaled, in case of spatial enhancement) reconstructed macroblock data, in the pixel domain, of the base layer. The second signal can be the reconstructed information from the enhancement layer bitstream, that has been created using essentially the same reconstruction algorithm as used in non-layered coding. An encoder can choose the weighting value and can vary the number of bits spent on the enhancement layer (thereby varying the fidelity of the enhancement layer signal before weighting) so to optimize coding efficiency. One potential disadvantage of MPEG-2's scalability approach is that the weighting factor, which is signaled at the fine granularity of the macroblock level, can use too many bits to allow for good coding efficiency of the enhancement layer. Another potential disadvantage is that a decoder can need to use both mentioned signals to reconstruct a single enhancement layer macroblock, leading to more cycles and/or memory bandwidth compared to single layer decoding.

ITU Rec. H.263 version 2 (1998) and later (available from International Telecommunication Union (ITU), Place des Nations, 1211 Geneva 20, Switzerland, and incorporated herein by reference in its entirety) also includes scalability mechanisms allowing temporal, spatial, and SNR scalability. Specifically, an SNR enhancement layer according to H.263 Annex O is a representation of what H.263 calls the “coding error”, which is calculated between the reconstructed image of the base layer and the source image. An H.263 spatial enhancement layer is decoded from similar information, except that the base layer reconstructed image has been upsampled before calculating the coding error, using an interpolation filter. One potential disadvantage of H.263's SNR and spatial scalability tool is that the base algorithm used for coding both base and enhancement layer(s), motion compensation and transform coding of the residual, may not be well suited to address the coding of a coding error; instead it is directed to the encoding of input pictures.

ITU-T Rec. H.264 version 2 (2005) and later (available from International Telecommunication Union (ITU), Place des Nations, 1211 Geneva 20, Switzerland, and incorporated herein by reference in its entirety), and their respective ISO-IEC counterpart ISO/TEC 14496 Part 10 includes scalability mechanisms known as Scalable Video Coding or SVC, in its Annex G. Again, while the scalability mechanisms of H264 and Annex G include temporal, spatial, and SNR scalability (among others such as medium granularity scalability), the details of the mechanisms used to achieve scalable coding differ from those used in H.262 or H.263. Specifically, SVC does not code those coding errors. It also does not add g a weighting factor.

The spatial scalability mechanisms of SVC contain, among others, the following mechanisms for prediction. First, a spatial enhancement layer has essentially all non-scalable coding tools available for those cases where non-scalable prediction techniques suffice, or are advantageous, to code a given macroblock. Second, an I-BL macroblock type, when signaled in the enhancement layer, uses upsampled base layer sample values as predictors for the enhancement layer macroblock currently being decoded. There are certain constraints associated with the use of I-BL macroblocks, mostly related to single loop decoding, and for saving decoder cycles, which can hurt the coding performance of both base and enhancement layers. Third, when residual inter layer prediction is signaled for an enhancement layer macroblock, the base layer residual information (coding error) is upsampled and added to the motion compensated prediction of the enhancement layer, along with the enhancement layer coding error, so to reproduce the enhancement layer samples.

Spatial and SNR scalability can be closely related in the sense that SNR scalability, at least in some implementations and for some video compression schemes and standards, can be viewed as spatial scalability with an spatial scaling factor of 1 in both X and Y dimensions, whereas spatial scalability can enhance the picture size of a base layer to a larger format by, for example, factors of 1.5 to 2.0 in each dimension. Due to this close relation, described henceforth is only spatial scalability.

The specification of spatial scalability in all three aforementioned standards naturally differs due to different terminology and/or different coding tools of the non-scalable specification basis, and different tools used for implementing scalability. However, one exemplary implementation strategy for a scalable encoder configured to encode a base layer and one enhancement layer is to include two encoding loops; one for the base layer, the other for the enhancement layer. Additional enhancement layers can be added by adding more coding loops. Conversely, a scalable decoder can be implemented by a base decoder and one or more enhancement decoder(s). This has been discussed, for example, in Dugad, R, and Ahuja, N, “A Scheme for Spatial Scalability Using Nonscalable Encoders”, IEEE CSVT, Vol 13 No. 10, October 2003, which is incorporated by reference herein in its entirety.

Referring to FIG. 1, shown is a block diagram of such an exemplary prior art scalable encoder. It includes a video signal input (101), a downsample unit (102), a base layer coding loop (103), a base layer reference picture buffer (104) that can be part of the base layer coding loop but can also serve as an input to a reference picture upsample unit (105), an enhancement layer coding loop (106), and a bitstream generator (107).

The video signal input (101) can receive the to-be-coded video in any suitable digital format, for example according to ITU-R Rec. BT.601 (March 1982) (available from International Telecommunication Union (ITU), Place des Nations, 1211 Geneva 20, Switzerland, and incorporated herein by reference in its entirety). The term “receive” can involve pre-processing steps such as filtering, resampling to, for example, the intended enhancement layer spatial resolution, and other operations. The spatial picture size of the input signal is assumed herein to be the same as the spatial picture size of the enhancement layer. The input signal can be used in unmodified form (108) in the enhancement layer coding loop (106), which is coupled to the video signal input.

Coupled to the video signal input can also be a downsample unit (102). The purpose of the downsample unit (102) is to down-sample the pictures received by the video signal input (101) in enhancement layer resolution, to a base layer resolution. Video coding standards as well as application constraints can set constraints for the base layer resolution. The scalable baseline profile of H.264/SVC, for example, allows downsample ratios of 1.5 or 2.0 in both X and Y dimensions. A downsample ratio of 2.0 means that the downsampled picture includes only one quarter of the samples of the non-downsampled picture. In the aforementioned video coding standards, the details of the downsampling mechanism can be chosen freely, independently of the upsampling mechanism. In contrast, the aforementioned video coding standards specify the filter used for up-sampling, so to avoid drift in the enhancement layer coding loop (105).

The output of the downsampling unit (102) is a downsampled version of the picture as produced by the video signal input (109).

The base layer coding loop (103) takes the downsampled picture produced by the downsample unit (102), and encodes it into a base layer bitstream(110).

Many video compression technologies rely, among others, on inter picture prediction techniques to achieve high compression efficiency. Inter picture prediction allows for the use of information related to one or more previously decoded (or otherwise processed) picture(s), known as a reference picture, in the decoding of the current picture. Examples for inter picture prediction mechanisms include motion compensation, where during reconstruction blocks of pixels from a previously decoded picture are copied or otherwise employed after being moved according to a motion vector, or residual coding, where, instead of decoding pixel values, the potentially quantized difference between a (including in some cases motion compensated) pixel of a reference picture and the reconstructed pixel value is contained in the bitstream and used for reconstruction. Inter picture prediction is a key technology that can enable good coding efficiency in modern video coding.

Conversely, an encoder can also create reference picture(s) in its coding loop.

While in non-scalable coding, the use of reference pictures is of particular relevance in inter picture prediction, in case of scalable coding, reference pictures can also be relevant for cross-layer prediction. Cross-layer prediction can involve the use of a base layer's reconstructed picture, as well as other base layer reference picture(s) as a reference picture in the prediction of an enhancement layer picture. This reconstructed picture or reference picture can be the same as the reference picture(s) used for inter picture prediction. However, the generation of such a base layer reference picture can be required even if the base layer is coded in a manner, such as intra picture only coding, that would, without the use of scalable coding, not require a reference picture.

While base layer reference pictures can be used in the enhancement layer coding loop, shown here for simplicity is only the use of the reconstructed picture (the most recent reference picture) (111) for use by the enhancement layer coding loop. The base layer coding loop (103) can generate reference picture(s) in the aforementioned sense, and store it in the reference picture buffer (104).

The picture(s) stored in the reconstructed picture buffer (111) can be upsampled by the upsample unit (105) into the resolution used by the enhancement layer coding loop (106). The enhancement layer coding loop (106) can use the upsampled base layer reference picture as produced by the upsample unit (105) in conjunction with the input picture coming from the video input (101), and reference pictures (112) created as part of the enhancement layer coding loop in its coding process. The nature of these uses depends on the video coding standard, and has already been briefly introduced for some video compression standards above. The enhancement layer coding loop (106) can create an enhancement layer bitstream (113), which can be processed together with the base layer bitstream (110) and control information (not shown) so to create a scalable bitstream (114).

In more recent video coding standards such as H.264 and HEV), intra coding has also taken on an increased role.

At the time of writing, HEVC is under development in the Joint Collaborative Team for Video Coding (JCT-VC), and the current draft can be found at “Bross et. al., High efficiency video coding (HEVC) text specification draft 6, JCTVC-H1003_dK, February 2012” (henceforth referred to as “WD6” or “HEVC”), which is incorporated herein by reference in its entirety.

### SUMMARY

The disclosed subject matter provides techniques for prediction of a to-be-reconstructed block from enhancement layer data.

In one embodiment there is provided techniques for prediction of a to-be-reconstructed block from base layer data in conjunction with enhancement layer data.

In one embodiment, a video encoder includes an enhancement layer coding loop which can select two coding modes: pixel coding mode; and difference coding mode.

In the same or another embodiment, the encoder can include a determination module for use in the selection of coding modes.

In the same or another embodiment, the encoder can include a flag in a bitstream indicative of the coding mode selected.

In one embodiment, a decoder can include sub-decoders for decoding in pixel coding mode and difference coding mode.

In the same or another embodiment, the decoder can further extract from a bitstream a flag for switching between difference coding mode and pixel coding mode.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary scalable video encoder in accordance with Prior Art;

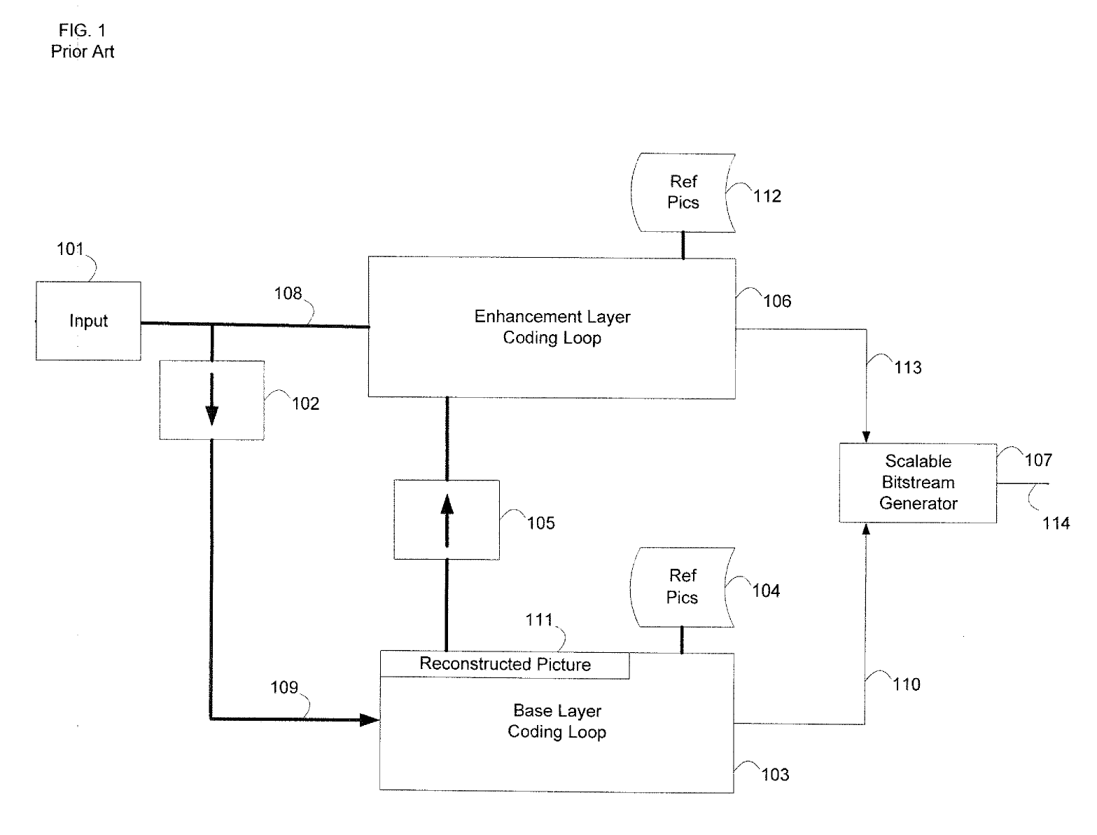

FIG. 2 is a schematic illustration of an exemplary encoder in accordance with an embodiment of the present disclosure;

FIG. 3 is a schematic illustration of an exemplary sub-encoder in pixel mode in accordance with an embodiment of the present disclosure;

FIG. 4 is a schematic illustration of an exemplary sub-encoder in difference mode in accordance with an embodiment of the present disclosure;

FIG. 5 is a schematic illustration of an exemplary decoder in accordance with an embodiment of the present disclosure;

FIG. 6 is a procedure for an exemplary encoder operation in accordance with an embodiment of the present disclosure;

FIG. 7 is a procedure for an exemplary decoder operation in accordance with an embodiment of the present disclosure; and

FIG. 8 shows an exemplary computer system in accordance with an embodiment of the present disclosure.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

Throughout the description of the disclosed subject matter the term “base layer” refers to the layer in the layer hierarchy on which the enhancement layer is based on. In environments with more than two enhancement layers, the base layer, as used in this description, does not need to be the lowest possible layer.

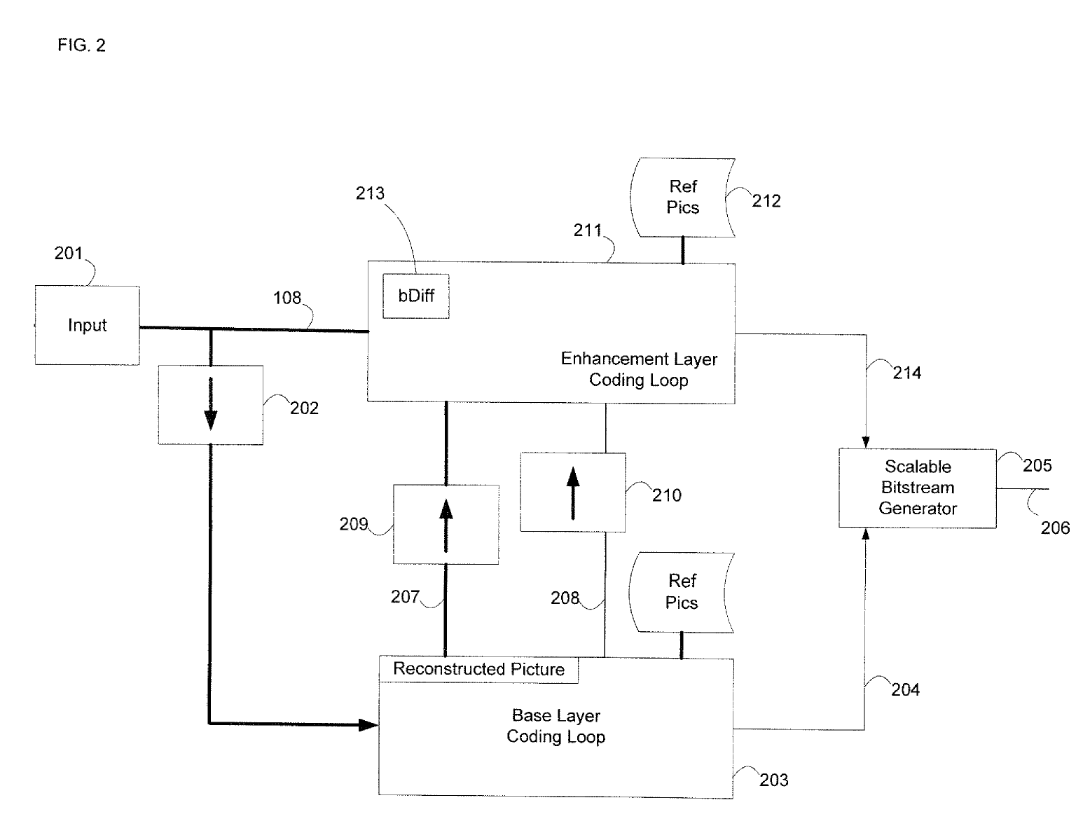

FIG. 2 shows a block diagram of a two layer encoder in accordance with the disclosed subject matter. The encoder can be extended to support more than two layers by adding additional enhancement layer coding loops.

The encoder can receive uncompressed input video (201), which can be downsampled in a downsample module (202) to base layer spatial resolution, and can serve in downsampled form as input to the base layer coding loop (203). The downsample factor can be 1.0, in which case the spatial dimensions of the base layer pictures are the same as the spatial dimensions of the enhancement layer pictures; resulting in a quality scalability, also known as SNR scalability. Downsample factors larger than 1.0 lead to base layer spatial resolutions lower than the enhancement layer resolution. A video coding standard can put constraints on the allowable range for the downsampling factor. The factor can also be dependent on the application,

The base layer coding loop can generate the following output signals used in other modules of the encoder:

A) Base layer coded bitstream bits (204) which can form their own, possibly self-contained, base layer bitstream, which can be made available by itself for example to base layer compatible decoders (not shown), or can be aggregated with enhancement layer bits and control information to a scalable bitstream generator (205), which can, in turn, generate a scalable bitstream (206) which can be decoded by a scalable decoder (not shown).

B) Reconstructed picture (or parts thereof) (207) of the base layer coding loop (base layer picture henceforth), in the pixel domain, of the base layer coding loop that can be used for cross-layer prediction. The base layer picture can be at base layer resolution, which, in case of SNR scalability, can be the same as enhancement layer resolution. In case of spatial scalability, base layer resolution can be different, for example lower, than enhancement layer resolution.

C) Reference picture side information (208). This side information can include, for example information related to the motion vectors that are associated with the coding of the reference pictures, macroblock or Coding Unit (CU) coding modes, intra prediction modes, and so forth. The “current” reference picture (which is the reconstructed current picture or parts thereof) can have more such side information associated with than older reference pictures.

Base layer picture and side information can be processed by an upsample unit (209) and an upscale units (210), respectively, which can, in case of the base layer picture and spatial scalability, upsample the samples to the spatial resolution of the enhancement layer using, for example, an interpolation filter that can be specified in the video compression standard. In case of reference picture side information, equivalent, for example scaling, transforms can be used. For example, motion vectors can be scaled by multiplying, in both X and Y dimension, the vector generated in the base layer coding loop (203).

An enhancement layer coding loop (211) can contain its own reference picture buffer(s) (212), which can contain reference picture sample data generated by reconstructing coded enhancement layer pictures previously generated, as well as associated side information.

In an embodiment of the disclosed subject matter, the enhancement layer coding loop further includes a bDiff determination module (213), whose operation is described later. It creates, for example, a given CU, macroblock, slice, or other appropriate syntax structure, a flag bDiff. The flag bDiff, once generated, can be included in the enhancement layer bitstream (214) at an appropriate syntax structure such as a CU header, macroblock header, slice header, or any other appropriate syntax structure. In order to simplify the description, henceforth, it is assumed that the bDiff flag is associated with a CU. The flag can be included in the bitstream by, for example, coding it directly in binary form into the header; group it with other header information and apply entropy coding to the grouped symbols (such as, for example Context-Adaptive Binary Arithmetic Coding, CABAC); or it can be inferred to through other entropy coding mechanisms. In other words, the bit may not be present in easily identifiable form in the bitstream, but may be available only through derivation from other bitstream data, The presence of bDiff (in binary form or derivable as described above) can be signaled by an enable signal, which can, for a plurality of CUs, macroblocks/slices, etc., its presence or absence. If the bit is absent, the coding mode can be fixed. The enable signal can have the form of a flag adaptive_diff_coding_flag, which can be included, directly or in derived form, in high level syntax structures such as, for example, slice headers or parameter sets.

In an embodiment, depending for the settings of the flag bDiff, the enhancement layer encoding loop (211) can select between, for example, two different encoding modes for the CU the flag is associated with. These two modes are henceforth referred to as “pixel coding mode” and “difference coding mode”.

“Pixel Coding Mode” refers to a mode where the enhancement layer coding loop, when coding the CU in question, can operate on the input pixels as provided by the uncompressed video input (201), without relying on information from the base layer such as, for example, difference information calculated between the input video and upscaled base layer data.

“Difference Coding Mode” refers to a mode where the enhancement layer coding loop can operate on a difference calculated between input pixels and upsampled base layer pixels of the current CU. The upsampled base layer pixels may be motion compensated and subject to intra prediction and other techniques as discussed below. In order to perform these operations, the enhancement layer coding loop can require upsampled side information. The inter picture layer prediction of the difference coding mode can be roughly equivalent to the inter layer prediction used the enhancement layer coding as described in Dugad and Ahuja (see above).

In the following, described is an enhancement layer coding loop (211) in both pixel coding mode and difference coding mode, separately by mode, for clarity. The mode in which the coding loop operates can be selected at, for example, CU granularity by the bDiff determination module (213). Accordingly, for a given picture, the loop may be changing modes at CU boundaries.

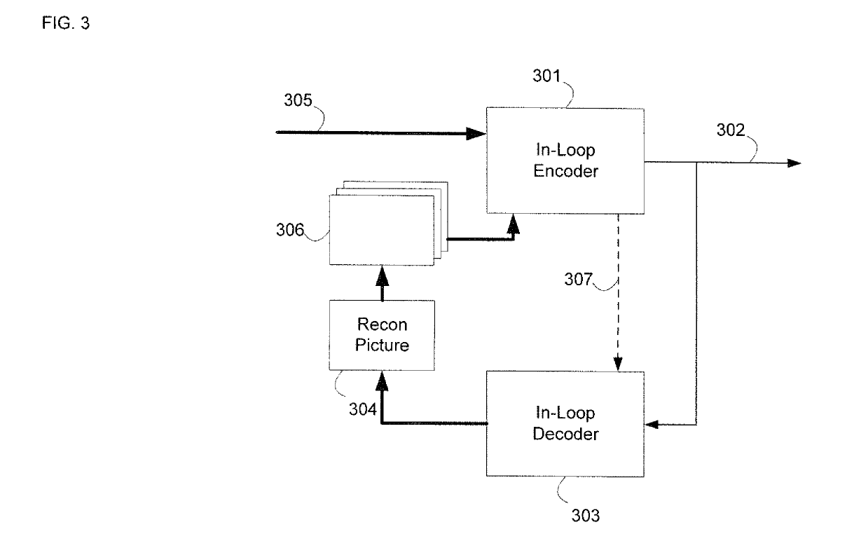

Referring to FIG. 3, shown is an exemplary implementation, following, for example, the operation of HEVC with minor modification(s) with respect to, for example, reference picture storage, of the enhancement layer coding loop in pixel coding mode. It should be emphasized that the enhancement layer coding loop could also be operating using other standardized or non-standardized non-scalable coding schemes, for example those of H.263 or H.264. Base layer and enhancement layer coding loop do not need to conform to the same standard or even operation principle.

The enhancement layer coding loop can include an in-loop encoder (301), which can be encoding input video samples (305). The in-loop encoder can utilize techniques such as inter picture prediction with motion compensation and transform coding of the residual. The bitstream (302) created by the in loop encoder (301) can be reconstructed by an in-loop decoder (303), which can create a reconstructed picture (304). The in-loop decoder can also operate on an interim state in the bitstream construction process, shown here in dashed lines as one alternative implementation strategy (307). One common strategy, for example, is to omit the entropy coding step, and operate the in-loop decoder (303) operate on symbols (before entropy encoding) created by the in-loop encoder (301). The reconstructed picture (304) can be stored as a reference picture in a reference picture storage (306) for future reference by the in-loop encoder (301). The reference picture in the reference picture storage (306) being created by the in loop decoder (303) can be in pixel coding mode, as this is what the in-loop encoder operates on.

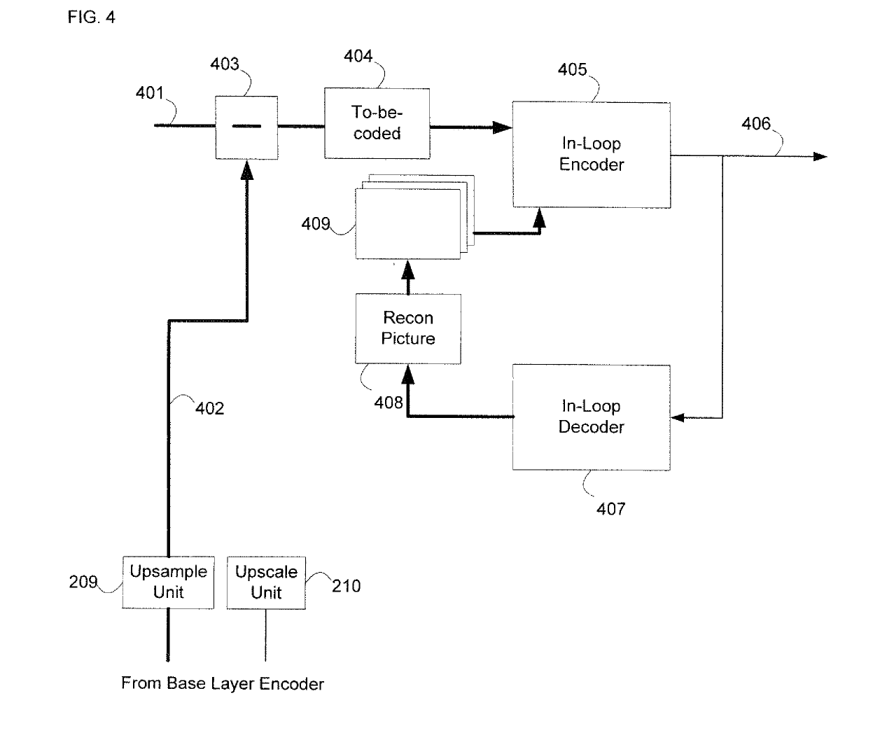

Referring to FIG. 4, shown is an exemplary implementation, following, for example the operation of HEVC with additions and modifications as indicated, of the enhancement layer coding loop in difference coding mode. The same remarks as made for the encoder coding loop in pixel mode can apply.

The coding loop can receive uncompressed input sample data (401). It further can receive upsampled base layer reconstructed picture (or parts thereof), and associated side information, from the upsample unit (209) and upscale unit (210), respectively. In some base layer video compression standards, there is no side information that needs to be conveyed, and, therefore, the upscale unit (210) may not exist.

In difference coding mode, the coding loop can create a bitstream that represents the difference between the input uncompressed sample data (401) and the upsampled base layer reconstructed picture (or parts thereof) (402) as received from the upsample unit (209). This difference is the residual information that is not represented in the upsampled base layer samples. Accordingly, this difference can be calculated by the residual calculator module (403), and can be stored in a to-be-coded picture buffer (404). The picture of the to-be-coded picture buffer (404) can be encoded by the enhancement layer coding loop according to the same or a different compression mechanism as in the coding loop for pixel coding mode, for example by an HEVC coding loop. Specifically, an in-loop encoder (405) can create a bitstream (406), which can be reconstructed by an in-loop decoder (407), so to generate a reconstructed picture (408). This reconstructed picture can serve as a reference picture in future picture decoding, and can be stored in a reference picture buffer (409). As the input to the in loop encoder has been a difference picture (or parts thereof) (409) created by residual calculator module, the reference picture created is also in difference coding mode, i.e., represent a coded coding error.

The coding loop, when in difference coding mode, operates on difference information calculated between upscaled reconstructed base layer picture samples and the input picture samples. When in pixel coding mode, it operates on the input picture samples. Accordingly, reference picture data can also be calculated either in the difference domain or in the source (aka pixel) domain. As the coding loop can change between the modes, based on the bDiff flag, at CU granularity, if the reference picture storage would naively store reference picture samples, the reference picture can contain samples of both domains. The resulting reference picture(s) can be unusable for an unmodified coding loop, because the bDiff determination can easily choose different modes for the same spatially located CUs over time.

There are several options to solve the reference picture storage problem. These options are based on the fact that it is possible, by simple addition/subtraction operations of sample values, to convert a given reference picture sample from difference mode to pixel mode, and vice versa. Specifically, for a reference picture in the enhancement layer, in order to convert a sample generated in difference mode to pixel mode, one can add the spatially corresponding sample of the upsampled base layer reconstructed picture to the coded difference values. Conversely, when converting from pixel mode into difference mode, one can subtract the spatially corresponding sample of the upsampled base layer reconstructed picture from the coded samples in the enhancement layer.

In the following, three of many possible options for reference picture storage in the enhancement layer coding loop are listed and described. A person skilled in the art can easily choose between those, or devise different ones, optimized for the hardware/software architecture he/she is basing his/her encoder design on.

One option is to generate enhancement layer reference pictures in both variants, pixel mode and difference mode, using the aforementioned addition/subtraction operations, This mechanism can double memory requirements but can have advantages when the decision process between the two modes involves coding, i.e. for exhaustive search motion estimation, and when multiple processors are available. For example, one processor can be tasked to perform motion search in the reference picture(s) in stored pixel mode, whereas another processor can perform a motion search in the reference picture(s) stored in difference mode.

Another option is to store the reference picture in for example, pixel mode only, and convert on-the-fly to difference mode in those cases where, for example, difference mode is chosen, using the non-upsampled base layer picture as storage. This option may make sense in memory-constrained, or memory-bandwidth constrained implementations, where it is more efficient to upsample and add/substraet samples than to store/retrieve those samples.

A different option involves storing the reference picture data, per CU, in the mode generated by the encoder, but add an indication in what mode the reference picture data of a given CU has been stored. This option can require on-the-fly conversion when the reference picture is being used in the encoding of later pictures, but can have advantages in architectures where storing information is much more computationally expensive than retrieval and/or computation.

Described now are certain features of the bDiff determination module (FIG. 2, 213).

Based on the inventors' experiments, it appears that the use of difference mode is quite efficient if the mode decision in the enhancement layer encoder has decided to use an Intra coding mode. Accordingly, in one embodiment, difference coding mode is chosen for all Intra CUs of the enhancement layer.

For inter CUs, no such simple rule of thumb was determined through experimentation. Accordingly, the encoder can use techniques that make an informed, content-adaptive decision to determine the use of difference coding mode or pixel coding mode. In the same or another embodiment, this informed technique can be to encode the CU in question in both modes, and select one of the two resulting bitstreams using Rate-Distortion Optimization techniques.

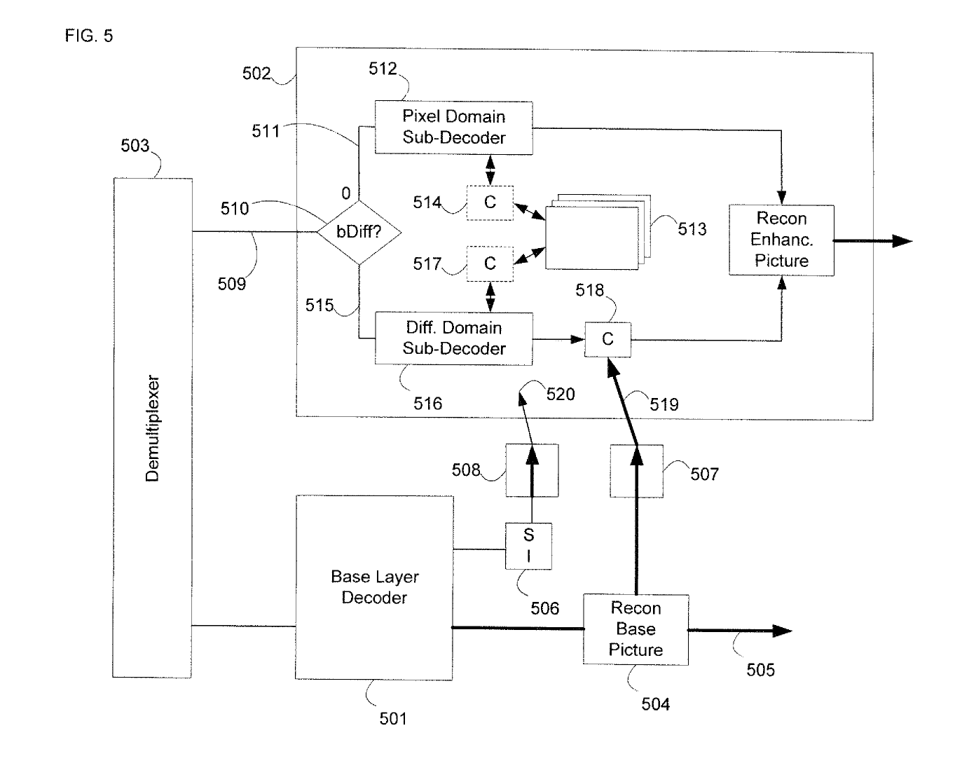

The scalable bitstream as generated by the encoder described above can be decoded by a decoder, which is described next with reference to FIG. 5.

A decoder according to the disclosed subject matter can contain two or more sub-decoders: a base layer decoder (501) for base layer decoding and one or more enhancement layer decoders for enhancement layer decoding. For simplicity, described is the decoding of a single base and a single enhancement layer only, and, therefore, only one enhancement layer decoder (502) is depicted.

The scalable bitstream can be received and split into base layer and enhancement layer bits by a demultiplexer (503). The base layer bits are decoded by the base layer decoder (501) using a decoding process that can be the inverse of the encoding process used to generate the base layer bitstream. A person skilled in the art can readily understand the relationship between an encoder, a bitstream, and a decoder.

The output of the base layer decoder can be a reconstructed picture, or parts thereof (504). In addition to its uses in conjunction with enhancement layer decoding, as described shortly, the reconstructed base layer picture (504) can also be output (505) and used by the overlying system. The decoding of enhancement layer data in difference coding mode in accordance with the disclosed subject matter can commence once all samples of the reconstructed base layer that are referred to by a given enhancement layer CU are available in the (possibly only partly) reconstructed base layer picture. Accordingly, it can be possible that base layer and enhancement layer decoding can occur in parallel. In order to simplify the description, henceforth, it is assumed that the base layer picture has been reconstructed in its entirety.

The output of the base layer encoder can also include side information (506), for example motion vectors, that can be utilized by the enhancement layer decoder, possibly after upscaling, as disclosed in co-pending U.S. patent application Ser. No. 13/528,169, titled “Motion Prediction in Scalable Video Coding,” filed Jun. 20, 2012 which is incorporated herein by reference in its entirety.

The base layer reconstructed picture or parts thereof can be upsampled in an upsample unit (507), for example, to the resolution used in the enhancement layer. The upsampling can occur in a single “batch” or as needed, “on the fly”. Similarly, the side information (506), if available, can be upsealed by upscaling unit (508)

The enhancement layer bitstream (509) can be input to the enhancement layer decoder (502). The enhancement layer decoder can, for example per CU, macroblocks, or slice, decode a flag bDiff (510) that can indicate, for example, the use of difference coding mode or pixel coding mode for a given CU, macroblock, or slice. Options for the representation of the flag in the enhancement layer bitstream have already been described.

The flag can be controlling the enhancement layer decoder by switching between two modes of operation: difference coding mode and pixel coding mode. For example, if bDiff is 0, pixel coding mode can be chosen (511) and that part of the bitstream is decoded in pixel mode.

In pixel coding mode, the sub-decoder (512) can reconstruct the CU/macroblock/slice in the pixel domain in accordance with a decoder specification that can be the same as used in the base layer decoding. The decoding can, for example, be in accordance with HEVC. If the decoding involves inter picture prediction, one or more reference picture(s) may be required, that can be stored in the reference picture buffer (513). The samples stored in the reference picture buffer can be in the pixel domain, or can be converted from a different form of storage into the pixel domain on the fly by a converter (514). The converter (514) is depicted in dashed lines, as it may not be necessary when the reference picture storage contains reference pictures in pixel domain format.

In difference coding mode (515), a sub decoder (516) can reconstruct a CU/macroblock/slice in the difference picture domain, using the enhancement layer bitstream. If the decoding involves inter picture prediction, one or more reference picture(s) may be required, that can be stored in the reference picture buffer (513). The samples stored in the reference picture buffer can be in the difference domain, or can be converted from a different form of storage into the difference domain on the fly by a converter (517). The converter (517) is depicted in dashed lines, as it may not be necessary when the reference picture storage contains reference pictures in pixel domain format. Options for reference picture storage, and conversion between the domains, have already been described in the encoder context.

The output of the sub decoder (516) is a picture in the difference domain. In order to be useful for, for example, rendering, it needs to be converted into the pixel domain. This can be done using a converter (518).

All three converters (514) (517) (518) follow the principles already described in the encoder context. In order to function, they may need access to upsampled base layer reconstructed picture samples (519). For clarity, the input of the upsampled base layer reconstructed picture samples is shown only into converter (518). Upscaled side information (520) can be required for decoding in both pixel domain sub-decoder (for example, when inter-layer prediction akin the one used in SVC is implemented in sub decoder (512)), and in the difference domain sub-decoder. The input is not shown.

An enhancement layer encoder can operate in accordance with the following procedure. Described is the use of two reference picture buffers, one in difference mode and the other in pixel mode.

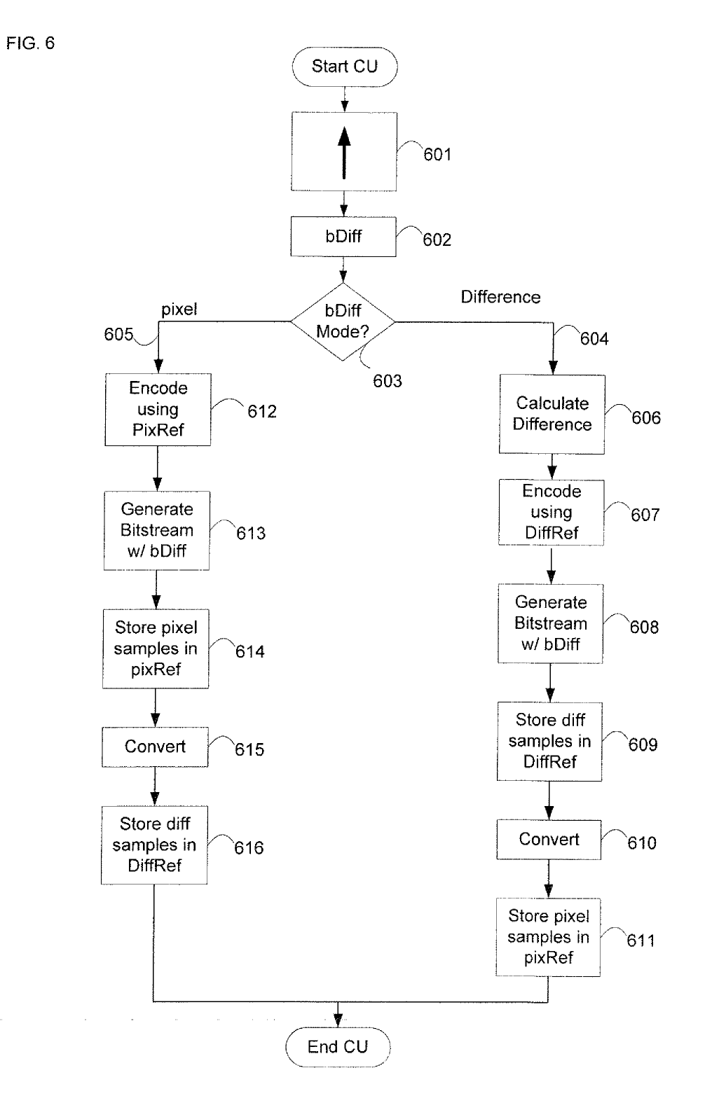

Referring to FIG. 6, and assuming that the samples that may be required for difference mode encoding of a given CU are already available in the base layer decoder:

In one embodiment, all samples and associated side information that may be required to code, in difference mode, a given CU/macroblock/slice (CU henceforth) are upsampled/upscaled (601) to enhancement layer resolution.

In the same or another embodiment, the value of a flag bDlff is determined (602), for example as already described.

In the same or another embodiment, different control paths (604) (605) can be chosen (603) based on the value of bDiff. Specifically control path (604) is chosen when bDiff indicates the use of difference coding mode, whereas control path (605) is chosen when bDiff indicates the use of pixel coding mode.

In the same or another embodiment, when in difference mode (604), a difference can be calculated (606) between the upsampled samples generated in step (601) and the samples belonging to the CU/macroblock/slice of the input picture. The difference samples can be stored (606).

In the same or another embodiment, the stored difference samples of step (606) are encoded (607) and the encoded bitstream, which can include the bDiff flag either directly or indirectly as already discussed, can be placed into the scalable bitstream (608).

In the same or another embodiment, the reconstructed picture samples generated by the encoding (607) can be stored in the difference reference picture storage (609).

In the same or another embodiment, the reconstructed picture samples generated by the encoding (607) can be converted into pixel coding domain, as already described (610).

In the same or another embodiment, the converted samples of step (610) can be stored in the pixel reference picture storage (611).

In the same or another embodiment, if path (605) (and, thereby, pixel coding mode) is chosen, samples of the input picture can be encoded (612) and the created bitstream, which can include the bDiff flag either directly or indirectly as already discussed, can be placed into the scalable bitstream (613).

In the same or another embodiment, the reconstructed picture samples generated by the encoding (612) can be stored in the pixel domain reference picture storage (614).

In the same or another embodiment, the reconstructed picture samples generated by the encoding (612) can be converted into difference coding domain, as already described (615).

In the same or another embodiment, the converted samples of step (615) can be stored in the difference reference picture storage (616).

An enhancement layer decoder can operate in accordance with the following procedure. Described is the use of two reference picture buffers, one in difference mode and the other in pixel mode.

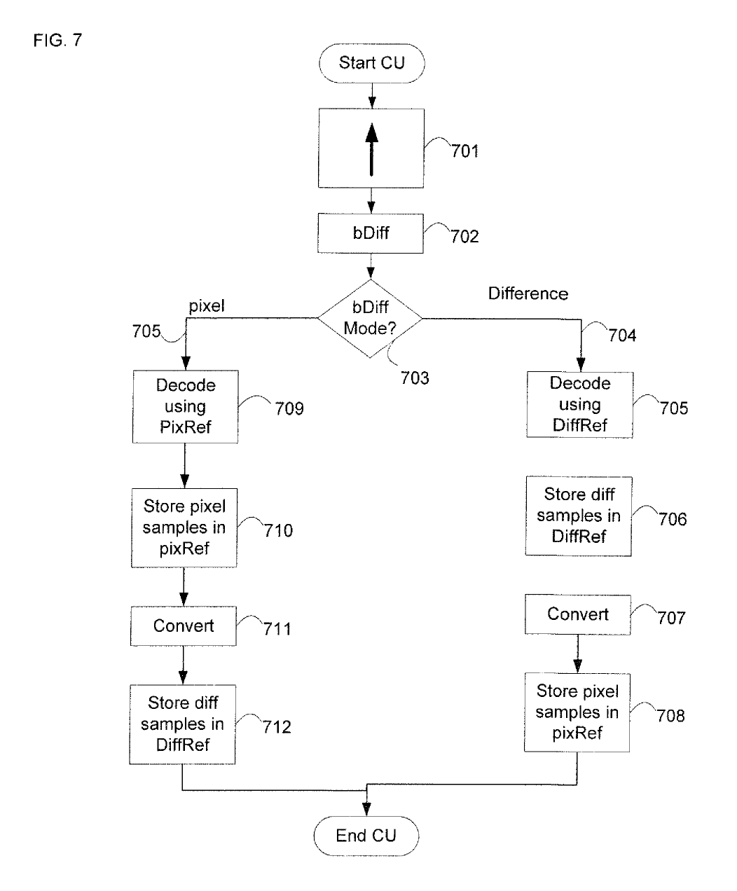

Referring to FIG. 7, and assuming that the samples that may be required for difference mode decoding of a given CU are already available in the base layer decoder:

In one embodiment, all samples and associated side information that may be required to decode, in difference mode, a given CU/macroblock/slice (CU henceforth) are upsampled/upscaled (701) to enhancement layer resolution.

In the same or another embodiment, the value of a flag bDiff is determined (702), for example by parsing the value from the bitstream where bDiff can be included directly or indirectly, as already described.

In the same or another embodiment, different control paths (704) (705) can be chosen (703) based on the value of bDiff. Specifically control path (704) is chosen when bDiff indicates the use of difference coding mode, whereas control path (705) is chosen when bDiff indicates the use of pixel coding mode.

In the same or another embodiment, when in difference mode (704), the bitstream can be decoded and a reconstructed CU generated, using reference picture information (when required) that is in the difference domain (705). Reference picture information may not be required, for example, when the CU in question is coded in intra mode.

In the same or another embodiment, the reconstructed samples can be stored in the difference domain reference picture buffer (706).

In the same or another embodiment, the reconstructed picture samples generated by the decoding (705) can be converted into pixel coding domain, as already described (707).

In the same or another embodiment, the converted samples of step (707) can be stored in the pixel reference picture storage (708).

In the same or another embodiment, if path (705) (and, thereby, pixel coding mode) is used, the bitstream can be decoded and a reconstructed CU generated, using reference picture information (when required) that is in the pixel domain (709).

In the same or another embodiment, the reconstructed picture samples generated by the decoding (709) can be stored in the pixel reference picture storage (710).

In the same or another embodiment, the reconstructed picture samples generated by the encoding (709) can be converted into difference coding domain, as already described (711).

In the same or another embodiment, the converted samples of step (711) can be stored in the difference reference picture storage (712).

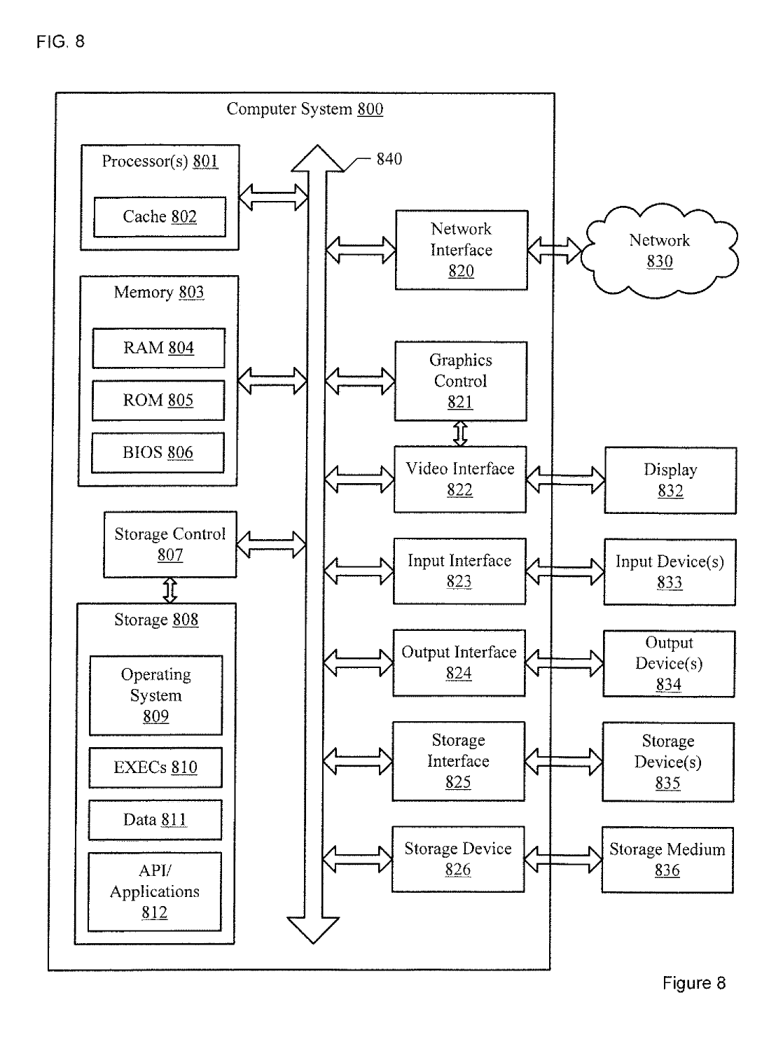

The methods for scalable coding/decoding using difference and pixel mode, described above, can be implemented as computer software using computer-readable instructions and physically stored in computer-readable medium. The computer software can be encoded using any suitable computer languages. The software instructions can be executed on various types of computers. For example, FIG. 8 illustrates a computer system 800 suitable for implementing embodiments of the present disclosure.

The components shown in FIG. 8 for computer system 800 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 800 can have many physical forms including an integrated circuit, a printed circuit board, a small handheld device (such as a mobile telephone or PDA), a personal computer or a super computer.

Computer system 800 includes a display 832, one or more input devices 833 (e.g., keypad, keyboard, mouse, stylus, etc.), one or more output devices 834 (e.g., speaker), one or more storage devices 835, various types of storage medium 836.

The system bus 840 link a wide variety of subsystems. As understood by those skilled in the art, a “bus” refers to a plurality of digital signal lines serving a common function. The system bus 840 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 801 (also referred to as central processing units, or CPUs) optionally contain a cache memory unit 802 for temporary local storage of instructions, data, or computer addresses. Processor(s) 801 are coupled to storage devices including memory 801 Memory 803 includes random access memory (RAM) 804 and read-only memory (ROM) 805. As is well known in the art, ROM 805 acts to transfer data and instructions uni-directionally to the processor(s) 801, and RAM 804 is used typically to transfer data and instructions in a bi-directional manner. Both of these types of memories can include any suitable of the computer-readable media described below.

A fixed storage 808 is also coupled bi-directionally to the processor(s) 801, optionally via a storage control unit 807. It provides additional data storage capacity and can also include any of the computer-readable media described below. Storage 808 can be used to store operating system 809, EXECs 810, application programs 812, data 811 and the like and is typically a secondary storage medium (such as a hard disk) that is slower than primary storage. It should be appreciated that the information retained within storage 808, can, in appropriate cases, be incorporated in standard fashion as virtual memory in memory 803.

Processor(s) 801 is also coupled to a variety of interfaces such as graphics control 821, video interface 822, input interface 823, output interface 824, storage interface 825, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 801 can be coupled to another computer or telecommunications network 830 using network interface 820. With such a network interface 820, it is contemplated that the CPU 801 might receive information from the network 830, or might output information to the network in the course of performing the above-described method, Furthermore, method embodiments of the present disclosure can execute solely upon CPU 801 or can execute over a network 830 such as the Internet in conjunction with a remote CPU 801 that shares a portion of the processing.

According to various embodiments, when in a network environment, i.e., when computer system 800 is connected to network 830, computer system 800 can communicate with other devices that are also connected to network 830. Communications can be sent to and from computer system 800 via network interface 820. For example, incoming communications, such as a request or a response from another device, in the form of one or more packets, can be received from network 830 at network interface 820 and stored in selected sections in memory 803 for processing. Outgoing communications, such as a request or a response to another device, again in the form of one or more packets, can also be stored in selected sections in memory 803 and sent out to network 830 at network interface 820. Processor(s) 801 can access these communication packets stored in memory 803 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 800 can provide functionality as a result of processor(s) 801 executing software embodied in one or more tangible, computer-readable media, such as memory 803. The software implementing various embodiments of the present disclosure can be stored in memory 803 and executed by processor(s) 801. A computer-readable medium can include one or more memory devices, according to particular needs. Memory 803 can read the software from one or more other computer-readable media, such as mass storage device(s) 835 or from one or more other sources via communication interface. The software can cause processor(s) 801 to execute particular processes or particular parts of particular processes described herein, including defining data structures stored in memory 803 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

We claim:

1. A method for decoding video encoded in a base layer and at least one enhancement layer and having at least a difference mode and pixel mode, comprising;
decoding at least one flag bDiff indicative of a choice between the difference mode and the pixel mode, and
as indicated by the at least one flag bDiff, reconstructing at least one sample in difference mode or pixel mode.

2. The method of claim 1, wherein bDiff is coded in a Coding Unit header.

3. The method of claim 2, wherein bDiff is coded in a Context-Adaptive Binary Arithmetic Coding.

4. The method of claim 1, wherein bDiff is coded in a slice header.

5. The method of claim 1, wherein reconstructing the at least one sample in difference mode comprises calculating a difference between a reconstructed, upsampled sample of the base layer and a reconstructed sample of the enhancement layer.

6. The method of claim 1, wherein the reconstructing the at least one sample in pixel mode comprises reconstructing the at least one sample of the enhancement layer.

7. A method for encoding video in scalable bitstream comprising a base layer and at least one enhancement layer, comprising:
for at least one sample at enhancement layer resolution, selecting between a difference mode and a pixel mode;
coding the at least one sample in the selected difference mode or pixel mode; and
coding an indication of the selected mode as a flag bDiff in the enhancement layer.

8. The method of claim 7, wherein the selection between difference mode and pixel mode comprises a rate-distortion optimization.

9. The method of claim 7, wherein the selection between difference mode and pixel mode is made for a coding unit.

10. The method of claim 9, wherein difference mode is selected when a mode decision process of an enhancement layer coding loop has selected intra coding for the coding unit.

11. The method of claim 7, wherein the flag bDiff is coded in a CU header.

12. The method of claim 11, wherein the flag bDiff coded in the CU header is coded in a Context-Adaptive Binary Arithmetic Coding format.

13. A system for decoding video encoded in a base layer and at least one enhancement layer and having at least a difference mode and pixel mode, comprising:
a base layer decoder for creating at least one sample of a reconstructed picture;
an upsample module coupled to the base layer decoder, for upsampling the at least one sample of a reconstructed picture to an enhancement layer resolution; and
an enhancement layer decoder coupled to the upsample module, the enhancement layer decoder being configured to
decode at least one flag bDiff from an enhancement layer bitstream,
decode at least one enhancement layer sample in the difference mode or the pixel mode selected by the flag bDiff,
receive at least one upsampled reconstructed base layer sample for use in reconstructing the enhancement layer sample when operating in difference mode as indicated by the flag bDiff.

14. A system for encoding video in a base layer and at least one enhancement layer using at least a difference mode and pixel mode comprising:
a base layer encoder having an output;
at least one enhancement layer encoder coupled to the base layer encoder;
an upsample unit, coupled to the output of the base layer encoder and configured to upsample at least one reconstructed base layer sample to an enhancement layer resolution, a bDiff selection module in the at least one enhancement layer encoder, the bDiff selection module being configured to select a value indicative of the pixel mode or the difference mode for a flag bDiff,
wherein the at least one enhancement layer encoder is configured to
encode at least one flag bDiff in an enhancement layer bitstream, and
encode at least one sample in difference mode, using the upsampled reconstructed base layer sample.

15. A non-transitory computer readable medium comprising a set of instructions to direct a processor to perform the methods in one of claims 1-12.
